(19) United States
(12) Patent Application Publication
(10) Pub. No.: US 2023/0245514 A1
(43) Pub. Date: Aug. 3, 2023

(54) CASH BOX HOLDING SYSTEM

(71) Applicant: Jose Luis Osuna Valerio, Tucson, AZ (US)

(72) Inventor: Jose Luis Osuna Valerio, Tucson, AZ (US)

(21) Appl. No.: 18/099,234

(22) Filed: Jan. 19, 2023

Related U.S. Application Data
(60) Provisional application No. 63/300,777, filed on Jan. 19, 2022.

(51) Int. Cl. G07C 9/00; H04N 7/18

(52) U.S. Cl. CPC G07C 9/00912; H04N 7/183

(57) ABSTRACT

The present invention is a cash box holding system, which provides a solution to the problem of securely holding and monitoring cashboxes in a casino or other location with cash boxes. The core components of the invention are a control system, cashbox holders with electronic locks, and surveillance cameras. Generally speaking, the components are configured as follows: The controller receives surveillance data from the surveillance cameras. The controller sends signals to the electronic locks of the cashbox holders to control access to cash boxes.

### CROSS REFERENCE TO RELATED APPLICATIONS

This application claims priority to U.S. Application No. 63/300,777 filed on Jan. 19, 2022 and is incorporated in its entirety.

### BACKGROUND

Casino tables have boxes for cash, chips, and other valuable items. These boxes are often secured to the table with a lock that requires a key to unlock. Complex check in and check out protocols for the keys that remove the boxes exist to tightly control access to the keys and prevent theft of these boxes. The boxes are often exchanged by security guards while the casino is open, so the risk of losing keys or having keys stolen by unknown parties is also a major concern. Lost or stolen keys can result in expensive lock changes needing to be made and also the potential for cashboxes to be stolen.

### SUMMARY

The disclosed device is unique when compared with other known devices and solutions because it provides a system that allows the cashboxes to be exchanged without needing keys. The system allows one worker to control electronic locks on cash box holders and also see when security guards are in proximity of the cash box holder and ready to exchange the cash boxes.

The disclosed device is unique in that it is structurally different from other known devices or solutions. More specifically, the device is unique due to the presence of: (1) electronic locks centrally controlled where the video surveillance is also viewable; and (2) keyless access to cash boxes.

### BRIEF DESCRIPTION OF DRAWINGS

FIG. 1 shows an example schematic view of a system.

FIG. 2 shows an example schematic view of connections between the controller and the surveillance cameras and electric locks.

FIG. 3 shows an example of a locked cash box holder.

FIG. 4 shows an example of an unlocked cash box holder with a cash box held therein.

### DETAILED DESCRIPTION

In the Summary above, in this Detailed Description, the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

The term “comprises” and grammatical equivalents thereof are used herein to mean that other components, ingredients, acts, etc. are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined acts, the defined acts can be carried out in any order or simultaneously (except where the context excludes that possibility), and the method can include one or more other acts which are carried out before any of the defined acts, between two of the defined acts, or after all the defined acts (except where the context excludes that possibility).

The term “at least” followed by a number is used herein to denote the start of a range including that number (which may be a range having an upper limit or no upper limit, depending on the variable being defined). For example, “at least 1” means 1 or more than 1. The term “at most” followed by a number is used herein to denote the end of a range, including that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number) - (a second number),” this means a range whose limits include both numbers. For example, “25 to 100” means a range whose lower limit is 25 and upper limit is 100 and includes both 25 and 100.

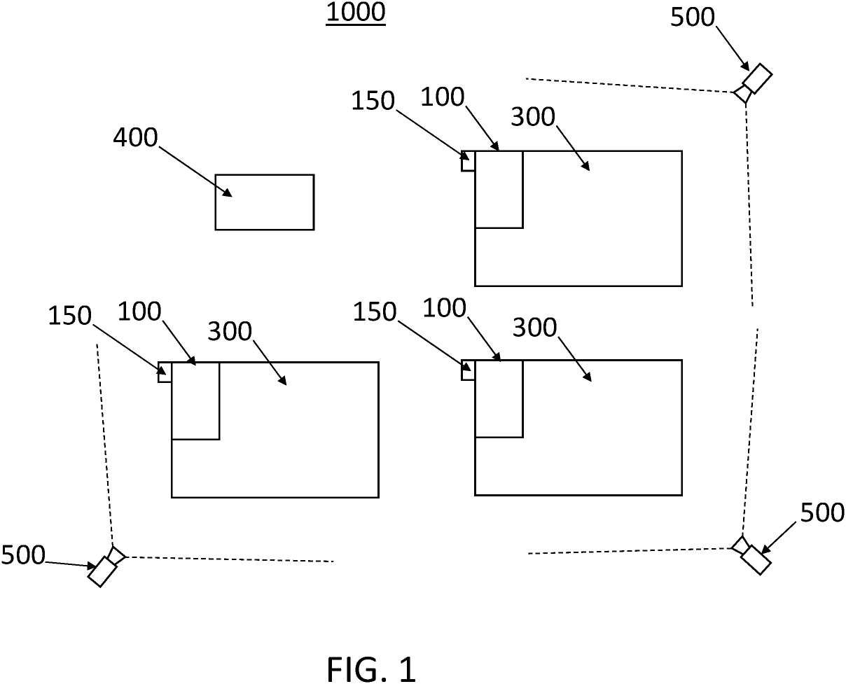

FIG. 1 shows an example schematic view of a system 1000. The system 1000 may include a controller 400, tables 300 with attached cash box holders 100 with electronic locks 150, and surveillance cameras 500. The controller 400 (as will be discussed in greater detail below) may be connected to and configured to control the electronic locks 150 and the surveillance cameras 500. The tables 300 may be game tables for playing casino games or other related activities. The cash box holders 100 may be fixed to the tables 300 and secure a cash box 200 (not shown in this figure) therein. The cash box holders 100 may include metal or other durable materials. The cashbox holders 100 may include an electronic lock 150 which when unlocked allows a cash box 200 to enter or leave the cash box holder 100.

The surveillance cameras 500 may be security cameras, digital cameras, or other forms of video devices that capture an image or stream of images. The surveillance cameras 500 may capture sound or may not. The surveillance cameras 500 may convey captured video to the controller 400. The controller 400 may include a display that can display the video. The controller 400 may include one or more computers or other electronic devices capable of viewing video and controlling electronic locks 150. The controller 400 may be in the same room as the tables 300 or may be in another room or even another building. Each table 300 may be within the view of or within the possible view of (if the cameras can move) at least one surveillance camera 500. In particular, the cash box holder 100 which may be mounted under the table 300 may be in view of the surveillance camera 500.

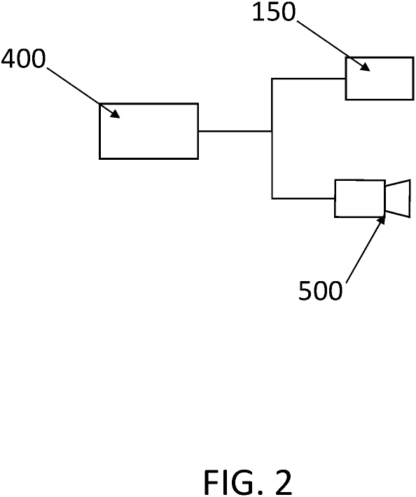

FIG. 2 shows an example schematic view of connections between the controller 400 and the surveillance cameras 500 and electric locks 150. The controller 400 may have a wired or wireless connection to the surveillance cameras 500 and the electronic locks 150. Encryptions and other security features may be required to maintain proper security for communications between the controller 400 and the surveillance cameras 500 and the electronic locks 150.

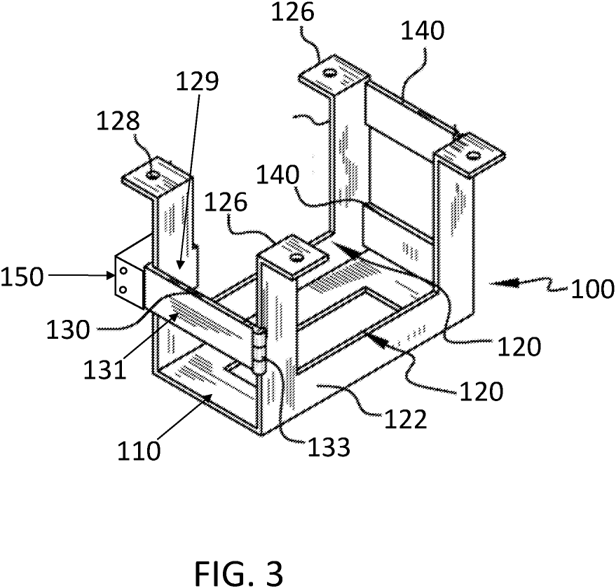

FIG. 3 shows an example of a locked cash box holder 100. The cash box holder may include base 110, sides 120 with horizontal extension 122 and vertical extensions 126, back plates 140, latch 130 with hinge 133, and electronic lock 150. Each side 120 may include at least one horizontal extension arranged to prevent a cash box from exiting sideways (e.g., passed the side 120). The vertical extensions 126 may extend vertically to connect the base 110 with the table 300. The vertical extensions 126 may include bolt holes 128 arranged to allow bolts to attach the cash box holder 100 to the table 300 so the cash box holder 100 may be permanently fixed to the table 300. The back plates 140 may extend between two of the vertical extension 126, one from each side 120 and be arranged to prevent a cash box 200 from exiting the back of the cash box holder 100 (e.g., passed the back plates).

The base 110 may attach to the sides 120 and be arranged to prevent the cash box 200 from exiting the base of the cash box holder 100 (e.g., passed the base 110. The cash box holder 100 may prevent the cash box from exiting in the top direction by being bolted under a table with the table 300 preventing the cash box 200 from leaving in an upward direction (e.g., direction opposite the base). The latch 130 may include a hinge 133 allowing a swinging latch 131 to rotate between a locked position and an open position to prevent or allow, respectively, the cash box from exiting through a front of the cash box 200 (e.g., through the direction opposite the back). The swinging latch 131 may be fixed in the locked position by the electronic lock 150. The swinging latch 131 in the locked position may extend from the hinge 133 attached to one of the vertical extensions 126 on one side 120 to the electronic lock 150 attached to the vertical extension 126 opposite on the other side 120. In the open position, the swinging latch 131 may be rotated away from the electronic lock 150 such that a cash box 200 may enter or exit via the front side. The electronic lock 150 may lock using an electronic actuator or other electronically activated device.

In some aspects, electric locks 150 are removable from a cash box holder 100. Electric locks can be removed for various maintenance and/or operational reasons, for example, to replace batteries, diagnose malfunctions, upgrade electric lock models, etc. In FIG. 3, one or more holes can be present in cash box holder 100 at or near area 129. The one or more holes can be matched to corresponding threaded holes of electric lock 150. Screws can go through the one or more holes at or near area 129 and screw into the matched threaded holes of electric lock 150. To remove electric lock 150, the screws can be unscrewed from the matched threaded holes. When maintenance or operational considerations are resolved, electric lock 150 (or a different electric lock) can be (re)secured to cash box holder 100 with screws.

When a cash box 200 is in cash box holder 100, access to area 129 is blocked by the cash box 200. As such, it is difficult, if not impossible, to remove screws from area 129 when a cash box 200 is in cash box holder 100. Should an electric lock 150 malfunction in a locked position when a cash box 200 is in cash box holder 100, a grinder or other tools can be used to cut through the lock and free swinging latch 131. Due to surveillance provided by cameras 500, it is unlikely a malfunctioning electric lock 150 can be worked on in an unplanned or nefarious manner.

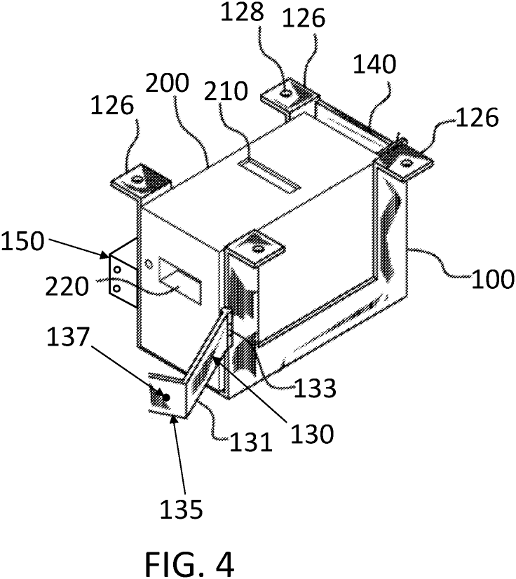

FIG. 4 shows an example of an unlocked cash box holder 100 with a cash box 200 held therein. The cash box 200 may include metal or other durable materials and have a 6-sided box shape. The cash box 200 may include first opening 210 in the top and second opening 220 in the front side. Through the first opening 210 and the second opening 220 cash or other objects may be inserted into the cashbox. The first opening 210 and the second opening 220 may be small enough that a human hand may not be able to reach into the box to retrieve the cash or other object. The table 300 (not shown in this figure) may include an opening that aligns with the first opening 210 such that cash can be placed into the first opening through the table 300. The cash box 200 may include a lock and may be opened using a key or other device for unlocking locks. The various parts of cash box 200 and table 300 may have oner or more liners for longevity and to prevent metal on metal on contact.

The swinging latch 131 is shown in the open position. The latch 130 may include a locking plate 135 with a locking hole 137. The locking plate 135 may be attached to the swinging latch 131 at the end of the swinging latch 131 opposite the hinge 133. The locking plate 135 may be arranged to contact the electronic lock 150 (when the swinging latch is in the closed position) such that the electronic lock 150 may actuate a pin to enter into the locking hole 137 to lock the latch 130 in the closed position. The swinging latch 131 and cash box 200 may have one or more sensors that may detect motion. The sensors may be a gyroscope or accelerometer that then sends a signal by one or more computing devices to a user of controller 400 remotely so they may detected unwanted entry into cash box 200.

The system 1000 may be used advantageously to allow for a keyless system of cash box 200 circulation (e.g., placing, replacing, and moving cash boxes 200). When cash boxes 200 need to be replaced, a user of the controller 400 and a security guard with replacement cashboxes may work together to securely replace the cash boxes 200 without keys. The user of the controller 400 may observe the movement of the security guard through the casino and when the security guard is near a cash box holder 100 with a cash box 200 that is to be replaced. The user of the controller may control the electronic lock 150 of the cash box holder 100 to unlock the electronic lock 150. The guard may then exchange the cash box 200 in the cash box holder 100 for a new cash box 200. The guard may then move on to another cash box holder 100 or return to the controller or a secure area where the contents of the cash box 200 can be dealt with.

Thus, in this way, the user of the controller 400 and the security guard can use the system 1000 to quickly and securely move the cash boxes 200. The user of the controller 400 and the security guard may also use radios or other communication devices to improve communication during movement of the cash boxes 200.

Accordingly, the present description provides for various embodiments for a system 1000 for surveying and controlling cash box holders 100. Many uses and advantages are offered by the system 1000 as described above in one or more non-limiting embodiments in the present description.

The corresponding structures, materials, acts, and equivalents of any means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention, according to one or more embodiments described in the present description, may be practiced with modification and alteration within the spirit and scope of the appended claims. Thus, the description is to be regarded as illustrative instead of restrictive of the present invention.

What is claimed is:

1. A system comprising:
one or more tables with a cash box holder with an electronic lock, the cash box holder configured to hold a cash box;
one or more surveillance cameras arranged to view the one or more tables and generate video of the one or more tables; and
a controller configured to receive the video of the one or more tables and control the electronic lock.

2. The system of claim 1, wherein the controller has a wired connection to the electronic lock.

3. The system of claim 1, wherein the controller has a wireless connection to the electronic lock.

4. The system of claim 1, wherein the cash box holder include a base, sides with a horizontal extension to prevent the cash box from exiting sideways and a vertical extensions, and back plates.

5. The system of claim 4, wherein the vertical extensions extend vertically to connect the base with the table.

6. The system of claim 5, wherein the vertical extensions include bolt holes arranged to allow bolts to attach the cash box holder to the table.

7. The system of claim 6, wherein the back plates extend between two of the vertical extensions, one from each side and arranged to prevent the cash box from exiting a back of the cash box holder.

8. The system of claim 7, wherein the base attach to the sides and be arranged to prevent the cash box from exiting the base of the cash box holder.

9. The system of claim 8, wherein the cash box holder include a swinging latch and a hinge that is configured to allow the swinging latch to rotate between a locked position and an open position to prevent and allow the cash box from exiting through a front of the cash box holder.

10. The system of claim 9, wherein the swinging latch is fixed in the locked position by the electronic lock.

11. The system of claim 10, wherein the swinging latch in the locked position extends from the hinge attached to one of the vertical extensions on one side to the electronic lock attached to the vertical extension on an opposite side.

12. The system of claim 11, wherein the swinging latch in the locked position extends from the hinge attached to one of the vertical extensions on one side to the electronic lock attached to the vertical extension on the opposite side.

13. The system of claim 12, wherein the swinging latch in the open position is rotated away from the electronic lock such that the cash box is able to enter or exit via a front side of the cash box holder.

14. The system of claim 1, wherein the electronic lock uses an electronic actuator to lock.

15. The system of claim 1, wherein the electronic lock is removable from the cash box holder.

16. A system comprising:
a plurality of tables each with a cash box holder having an electronic lock;
a cash box insertable into the cash box holder;
one or more surveillance cameras arranged to view the plurality of tables and generate video of the plurality of tables; and
a controller configured to receive the video of the plurality of tables and remotely control the electronic lock.

17. The system of claim 16, wherein the cash box has a first opening and a second opening.

18. The system of claim 16, wherein the cash box holder has a swinging latch that prevents the cash box from being removed.

19. The system of claim 18, wherein the swinging latch is connected to a locking plate with a locking hole.

20. The system of claim 19 wherein the locking plate is attached to the swinging latch at an end of the swinging latch opposite a hinge, wherein the locking plate is arranged to contact the electronic lock such that the electronic lock actuates a pin to enter into the locking hole to lock the swinging latch in a closed position.
